(19) United States
(12) Patent Application Publication
(10) Pub. No.: US 2015/0233555 A1
(43) Pub. Date: Aug. 20, 2015

(54) REPLACEABLE ELECTRONIC CANDLE WICK

(71) Applicant: NGATIK POON, HONG KONG (HK)

(72) Inventor: NGATIK POON, HONG KONG (HK)

(21) Appl. No.: 14/182,535

(22) Filed: Feb. 18, 2014

(51) Int. Cl. F21V 19/04; F21S 9/02; F21V 8/00; F21S 10/04; F21S 6/00

(52) U.S. Cl. CPC F21V 19/04; F21S 10/04; F21S 6/001; G02B 6/0096; F21S 9/02; F21Y 2101/02

(57) ABSTRACT

A wick assembly is configured to resemble a candle in a variety of settings. The wick assembly includes a wick. The wick has an upper LED facing upward mechanically coupled to at least two pins. Shrink wrap is around the upper LED and altering light diffused from the upper LED. A wick receptacle has a position socket and is configured to accommodate the pins. The upper LED is detachable from the position socket and is configured to be replaced if the upper LED burns out.

### BACKGROUND

The embodiments herein relate generally to devices the parts of which are specially shaped or arranged to resemble a candle or to permit the assembly to be enclosed in a relatively elongated tubular sheath having the appearance of a candle.

Prior to embodiments of the disclosed invention, replaceable electronic candle wicks were expensive to produce resulting the need to remove a sensor and replace it with a more efficient wick assembly. The prior art includes U.S. Pat. No. 6,616,308, U.S. Pat. No. 7,360,935, and U.S. Pat. No. 7,828,462 all issued to Jenson.

The '308 patent teaches placing a light emitting diode (LED) which is surrounded by a light diffusing body. The use of a single LED fails to adequately represent a candle wick when lit. The '935 patent teaches two collinear LEDs that are arranged with one LED in a light pipe and a second LED in an epoxy body. The difficulty with this arrangement is that instead of using a shrink-wrap, the epoxy body substantially absorbs light. This results in a duller appearance than embodiments of the present invention. Further, the '935 patent fails to be detachable from the base, making it difficult to replace. The '462 patent, likewise does not utilize a detachable wick.

### SUMMARY

A wick assembly can be configured to resemble a candle in a variety of settings. The wick assembly includes a wick. The wick has an upper LED facing upward mechanically coupled to at least two pins. Shrink wrap can be around the upper LED and altering light diffused from the upper LED. A wick receptacle has a position socket and can be configured to accommodate the pins. The upper LED can be detachable from the position socket and can be configured to be replaced if the upper LED burns out.

In some embodiments, the at least two pins are four pins and the upper LED can be an upper RGB LED. In some embodiments, a lower LED can be mechanically coupled to the at least two pins and soldered to the upper LED. The lower LED can be partially covered in the shrink wrap in order to alter diffused light from the lower LED.

In some embodiments, the at least two pins are four pins, the upper LED can be an upper RGB LED and the lower LED can be a lower RGB LED. In some embodiments, heat glue can covers an upper portion of the upper LED to provide muted lighting from the upper LED. In some embodiments, the lower LED can be facing upward to magnify the light from above the wick. In some embodiments, the lower LED can be facing upward to magnify the light from above the wick.

In some embodiments an electronic module can be electrically coupled to the wick receptacle wherein the electronic module further comprcan bees an integrated circuit board electrically coupled to power source. In some embodiments, a wax candle body can be configured to cover the wick receptacle and the electronic module to give the wick assembly an appearance of a wax candle. In some embodiments a tea candle body can be configured to cover the wick receptacle and the electronic module to give the wick assembly an appearance of a tea candle. In some embodiments, a jar candle body can be configured to cover the wick receptacle and the electronic module to give the wick assembly an appearance of a jar candle. In some embodiments, a stick candle body can be configured to cover the wick receptacle and the electronic module to give the wick assembly an appearance of a stick candle.

In some embodiments, the wick receptacle can be configured to accommodate four pins. An LED can be inserted into two pins on the wick receptacle. The upper LED can have two other pins that are bent at right angles to avoid interfering with the LED. In some embodiments, the wick receptacle can be detachable coupled to a cap made from transparent plastic covers the LED and the two pins to support an upright position of the wick.

### BRIEF DESCRIPTION OF THE FIGURES

The detailed description of some embodiments of the invention is made below with reference to the accompanying figures, wherein like numerals represent corresponding parts of the figures.

FIG. 1 shows a perspective view of an embodiment of the present invention.

FIG. 2 shows a perspective view of an embodiment of the present invention.

FIG. 3 is a section assembly view of an embodiment of the present invention.

FIG. 4 is a section assembly view of an embodiment of the present invention.

FIG. 5 is a section assembly view of an embodiment of the present invention.

FIG. 6 is a section assembly view of an embodiment of the present invention.

FIG. 7 is a section assembly view of an embodiment of the present invention.

FIG. 8 is a perspective assembly view of an embodiment of the present invention.

FIG. 9 is a perspective assembly view of an embodiment of the present invention.

FIG. 10 is a perspective assembly view of an embodiment of the present invention.

FIG. 11 is a perspective assembly view of an embodiment of the present invention.

FIG. 12 is a perspective assembly view of an embodiment of the present invention.

FIG. 13 is a perspective view of an embodiment of the present invention.

FIG. 14 shows a section view of an embodiment of the present invention.

FIG. 15 shows a perspective view of an embodiment of the present invention.

FIG. 16 shows a section view of an embodiment of the present invention.

FIG. 17 shows a perspective view of an embodiment of the present invention.

FIG. 18 shows a section view of an embodiment of the present invention.

FIG. 19 shows a perspective view of an embodiment of the present invention.

FIG. 20 shows a section view of an embodiment of the present invention.

FIG. 21 shows a perspective view of an embodiment of the present invention.

FIG. 22 shows a section view of an embodiment of the present invention.

FIG. 23 shows a perspective view of an embodiment of the present invention.

FIG. 24 shows a section view of an embodiment of the present invention.

FIG. 25 shows a perspective view of an embodiment of the present invention.

FIG. 26 shows a section view of an embodiment of the present invention.

FIG. 27 shows a perspective view of an embodiment of the present invention.

FIG. 28 shows a section view of an embodiment of the present invention.

### DETAILED DESCRIPTION OF CERTAIN EMBODIMENTS

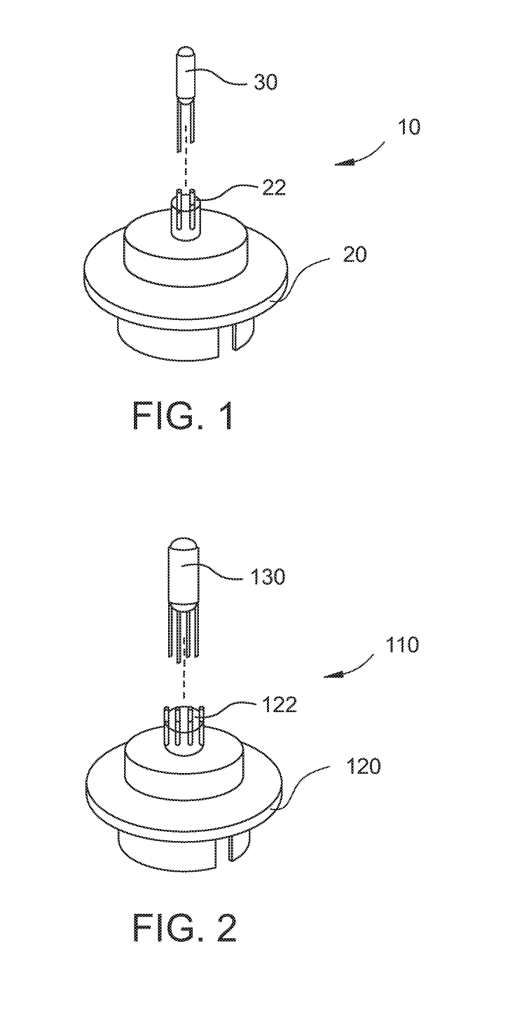

By way of example, and referring to FIG. 1, one embodiment of wick assembly 10 comprises wick receptacle 20 detachably coupled to two-pin wick 30. Wick receptacle 20 comprises two-pin position socket 22 which is configured to accommodate two-pin wick 30.

FIG. 2 shows wick assembly 110 comprising wick receptacle 120 detachably coupled to four-pin wick 130. Wick receptacle 120 comprises four-pin position socket 122 which is configured to accommodate four-pin wick 130.

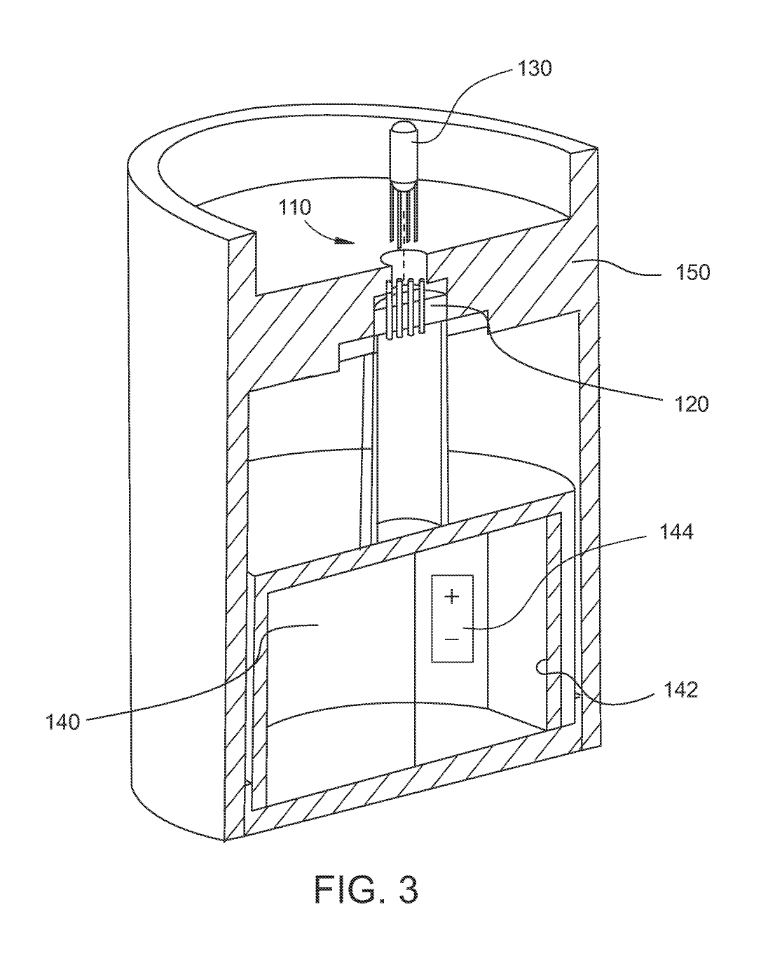

FIG. 3 shows wick assembly 110 in more detail. Wick receptacle 120 is electrically coupled to electronic module 140. Electronic module 140 further comprises integrated circuit board 142 electrically coupled to power source 144. Wick receptacle 120 and electronic module 140 are covered by wax candle body 150. Integrated circuit board 142 controls the functions of four-pin wick 130 which can include timers, light effects, on/off, and/or remote functionality. Four-pin wick 130 is detachable from the top of wax candle body 150. In this manner, a user can exchange different kind of four-pin wick 130 or replace a defective four-pin wick 130.

As noted in more detail below, two-pin wick 30 and four-pin wick 130 have slightly different physical characteristics. Two-pin wick 30 is assembled with two pin LEDs which are typically mono color LEDs. Four-pin wick 130 is assembled with four pin red green blue (RGB) LEDs, wherein the light color is changeable and programmable by integrated circuit board 142.

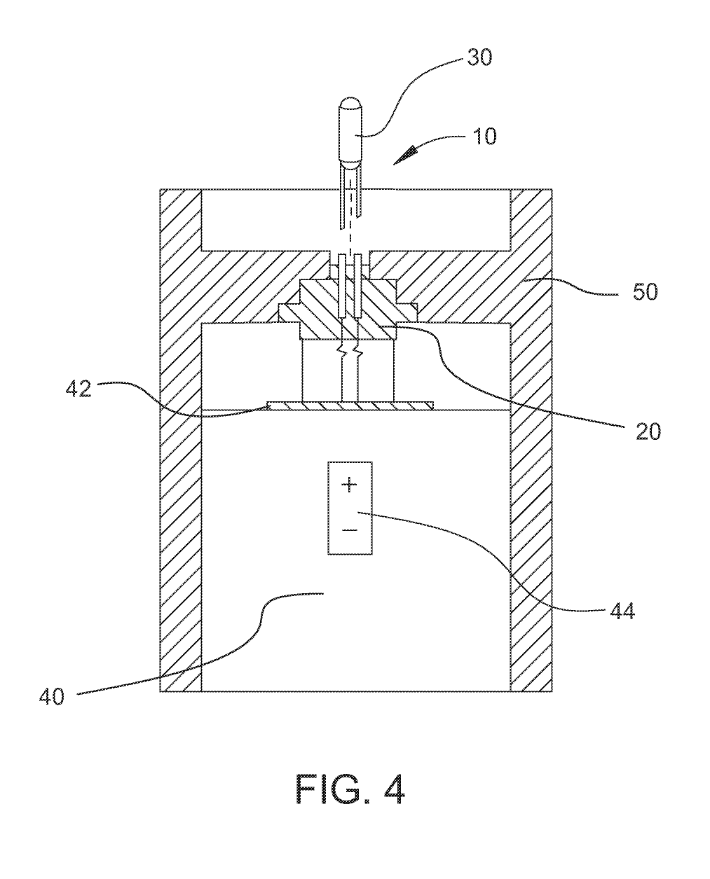

FIG. 4 shows wick assembly 10 in more detail. Wick receptacle 20 is electrically coupled to electronic module 40. Electronic module 40 further comprises integrated circuit board 42 electrically coupled to power source 44. Wick receptacle 20 and electronic module 40 are covered by wax candle body 50. Integrated circuit board 42 controls the functions of two-pin wick 30 which can include timers, light effects, on/off, and/or remote functionality. Two-pin wick 30 is detachable from the top of wax candle body 50. In this manner, a user can exchange different kind of two-pin wick 30 or replace a defective two-pin wick 30.

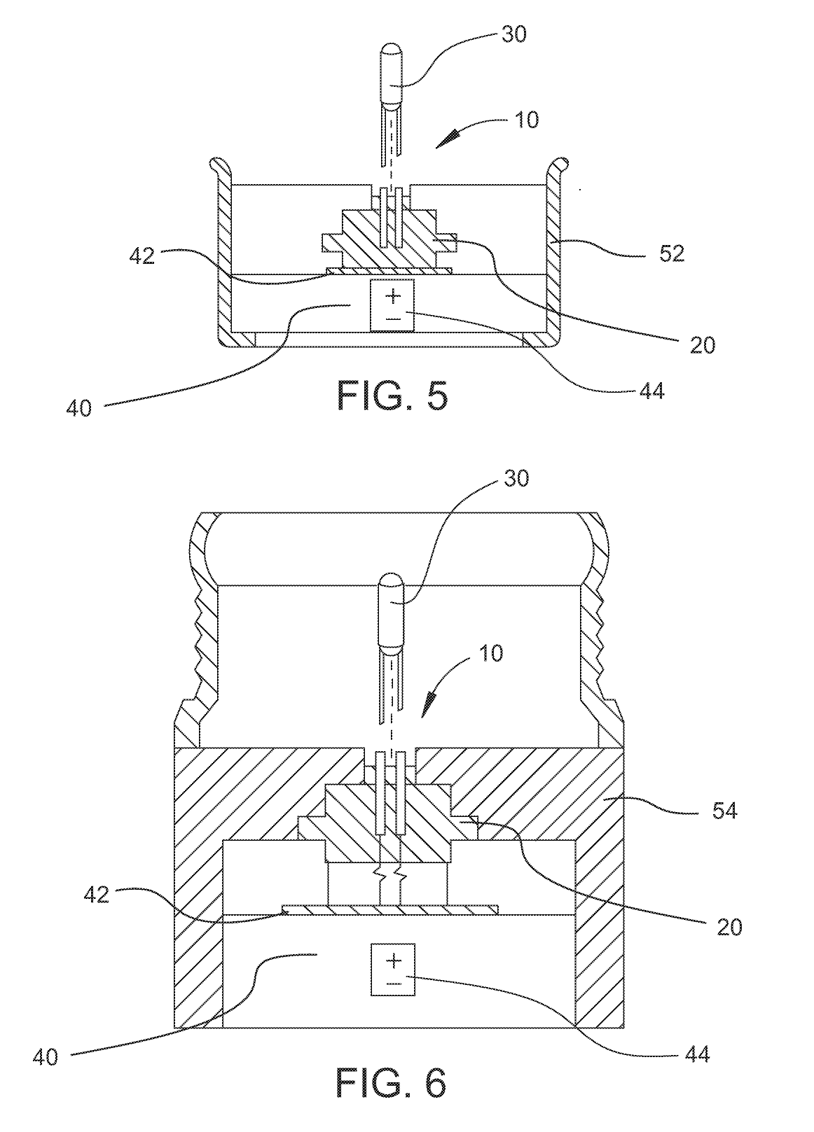

FIG. 5 shows wick assembly 10 inside of tea candle body 52 to form a tea candle. Here, two-pin wick 30 is detachably coupled to two-pin position socket 22, as above. However, two-pin position socket 22 is now attached to tea candle body 52. Much like wax candle body 50, tea candle body 52 is attached to electronic module 40.

FIG. 6 shows wick assembly 10 inside of jar candle body 54 to form a jar candle. Here, two-pin wick 30 is detachably coupled to two-pin position socket 22, as above. However, two-pin position socket 22 is now attached to jar candle body 54. Much like wax candle body 50, jar candle body 54 is attached to electronic module 40.

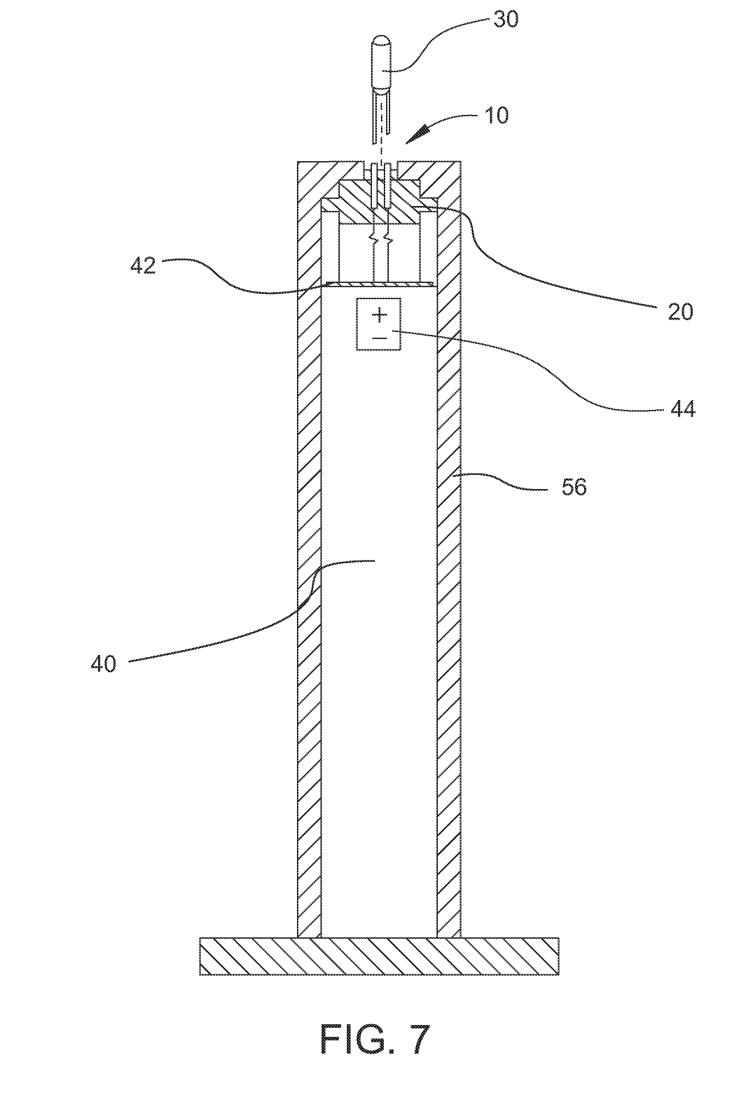

FIG. 7 shows wick assembly 10 inside of stick candle body 56 to form a stick candle. Here, two-pin wick 30 is detachably coupled to two-pin position socket 22, as above. However, two-pin position socket 22 is now attached to stick candle body 56. Much like wax candle body 50, stick candle body 56 is attached to electronic module 40.

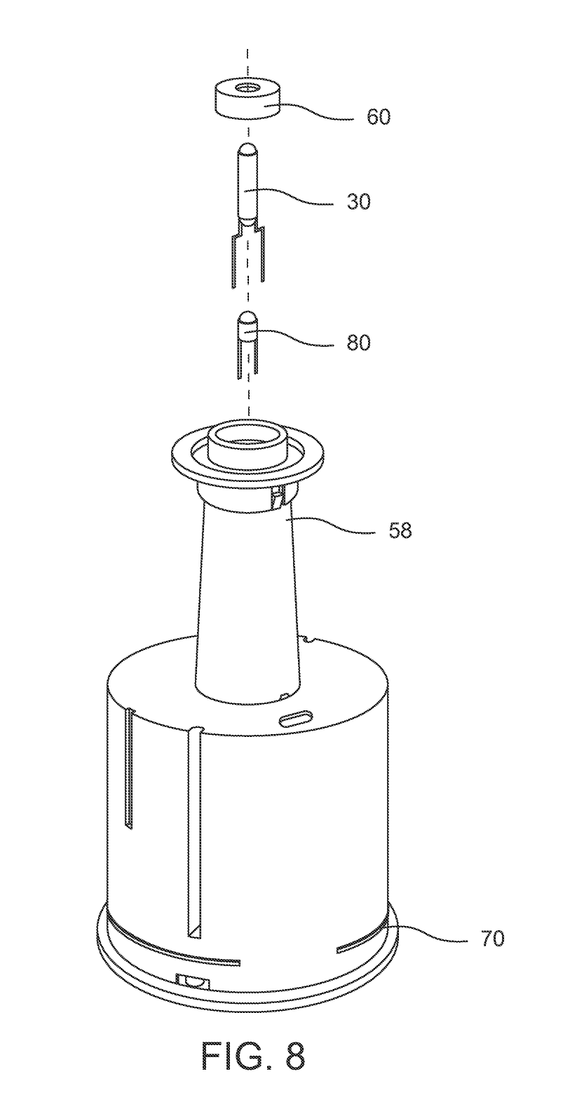

FIG. 8 shows an assembly view of a wick assembly. Two-pin wick 30 and two-pin LED 80 are detachably coupled to wick receptacle 58. The middle of the pins on two-pin wick 30 are bent into right angles to avoid touching the pins on two-pin LED 80. Wick receptacle 58 can be made from transparent plastic. The two-pin LED 80 is detachably coupled to wick receptacle 55 such that two-pin LED 80 is below the two-pin wick 30 to provide extra light source for the candle body. Cap 60 can be made from transparent plastic the covers the two-pin LED 80 and the wick pins to support an upright position of the two-pin wick 30. Two-pin wick 30 and two-pin LED 80 can be replaced and changed by removing cap 60. A lower part of the wick assembly comprises external threaded 70.

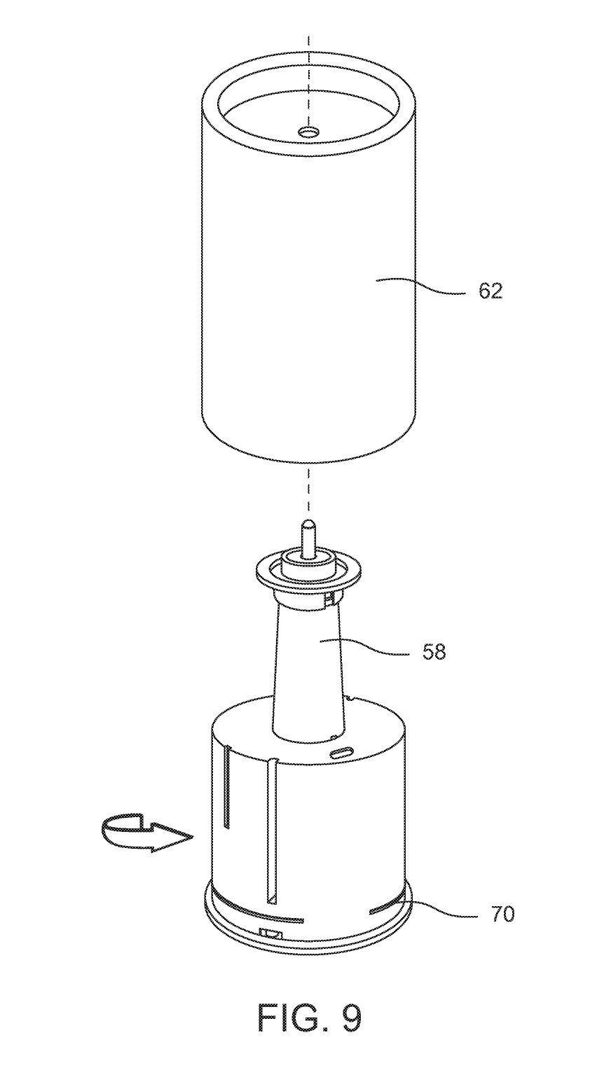

FIG. 9 shows an assembly view of a wick receptacle 58 covered with wax candle body 62. Wax candle body 62 comprises an internal thread which is mated with external thread 70 by rotating wax candle body 62 as shown. By attaching wax candle body 62 to wick receptacle 58 a user can simulate a wax candle. By removing wax candle body 62 from wick receptacle 58 a user can replace two-pin wick 30 or two-pin LED 80 in the same manner shown in FIG. 8.

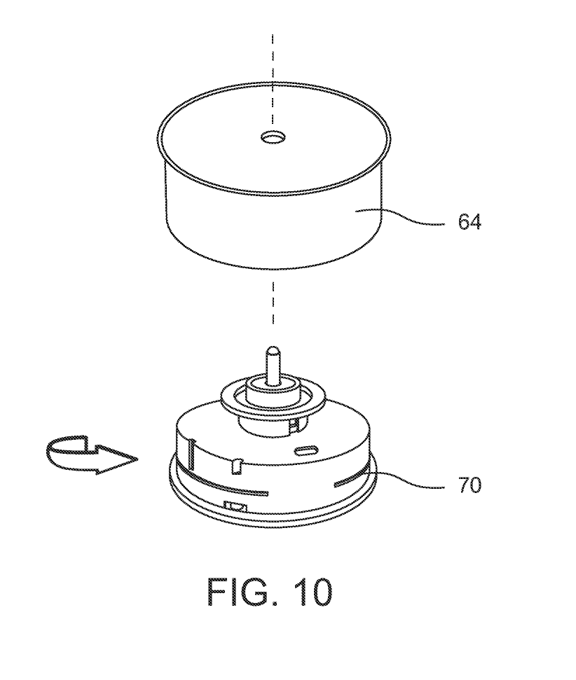

FIG. 10 shows an assembly view of a wick assembly covered with tea candle body 64. Tea candle body 64 comprises an internal thread which is mated with external thread 70 by rotating tea candle body 64 as shown. By attaching tea candle body 64 to the wick assembly a user can simulate a tea candle. By removing tea candle body 64 from wick assembly a user can replace two-pin wick 30 or two-pin LED 80 in the same manner shown in FIG. 5.

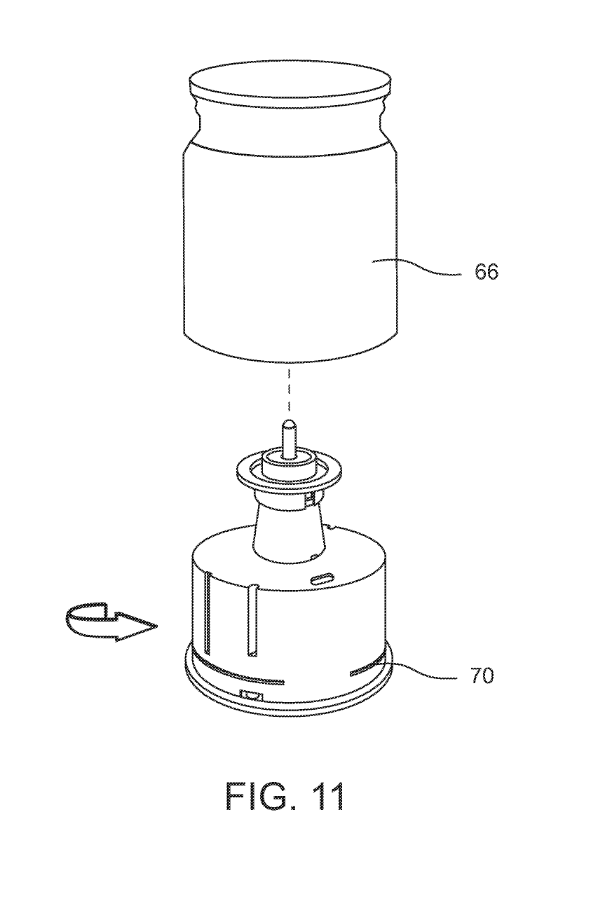

FIG. 11 shows an assembly view of a wick assembly covered with jar candle body 66. Jar candle body 66 comprises an internal thread which is mated with external thread 70 by rotating jar candle body 66 as shown. By attaching jar candle body 66 to the wick assembly a user can simulate a jar candle. By removing jar candle body 66 from wick assembly a user can replace two-pin wick 30 or two-pin LED 80 in the same manner shown in FIG. 6.

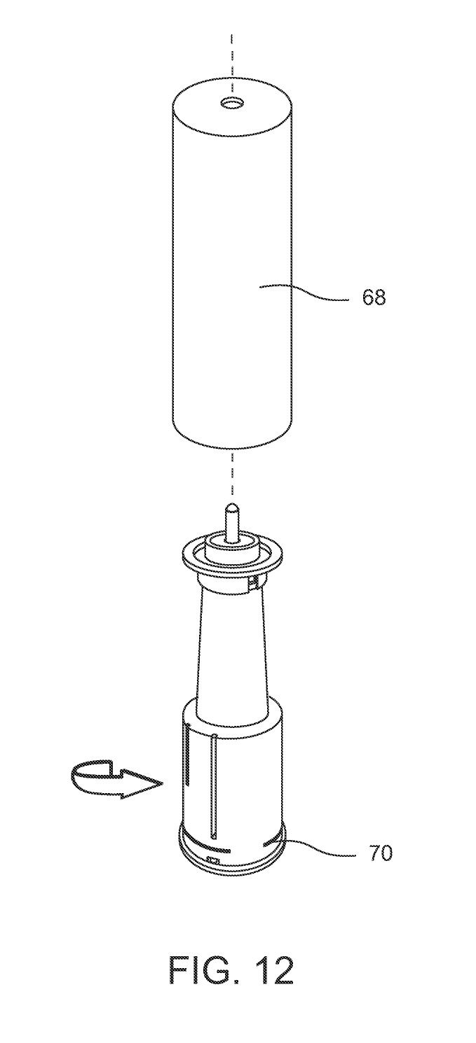

FIG. 12 shows an assembly view of a wick assembly covered with stick candle body 68. Stick candle body 68 comprises an internal thread which is mated with external thread 70 by rotating stick candle body 68 as shown. By attaching stick candle body 68 to the wick assembly a user can simulate a stick candle. By removing stick candle body 68 from wick assembly a user can replace two-pin wick 30 or two-pin LED 80 in the same manner shown in FIG. 7.

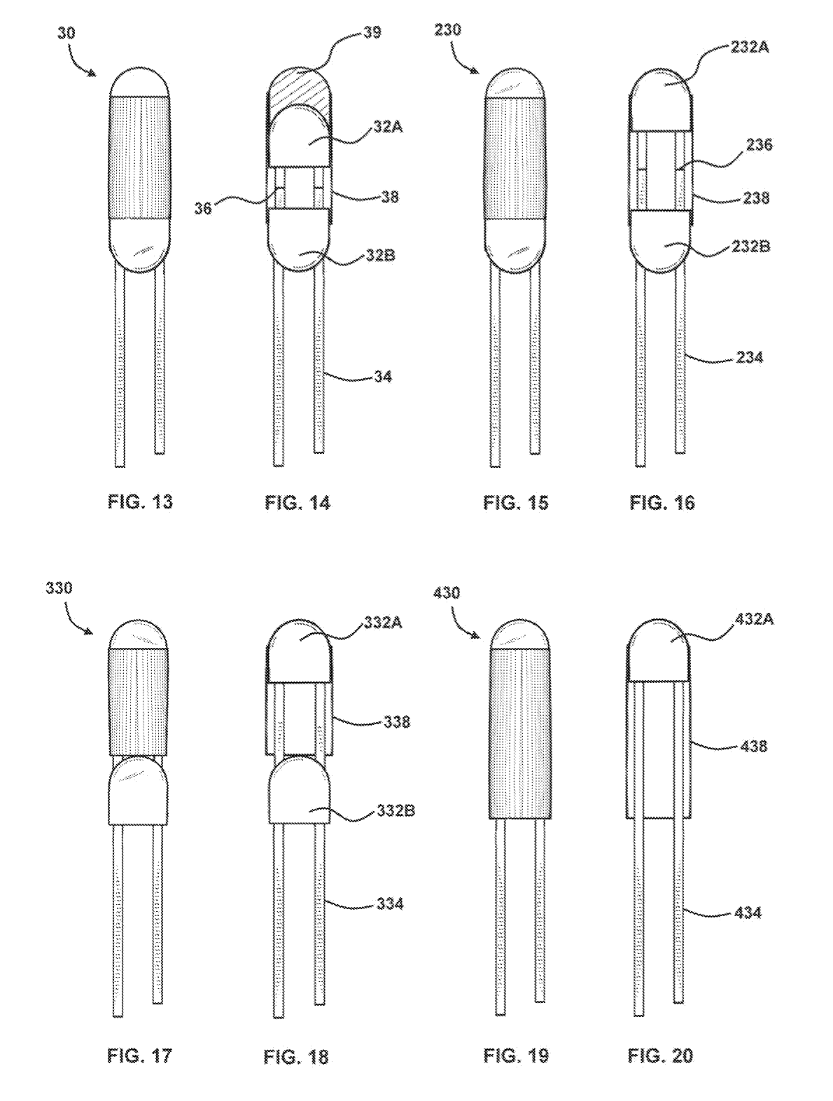

There are a variety of wicks that can be used to simulate different kinds of flames as shown in FIGS. 13 through 26.

Turning to FIG. 13 and FIG. 14, wick 30 comprises upper LED 32A, facing upward, mechanically coupled to lower LED 32B, facing downward, with solder 36. Lower LED 32B is further electrically coupled to two pins 34 which can be connected to two-pin position socket 22 as noted above. Wick 30 further comprises shrink tubing 38 fully covering upper LED 32A and partially covering the lower LED 32B to give wick 30 a real wick appearance. Clear heat glue 29 on the top of upper LED 32A reduces the sharpness of the light to give a softer light when a user is directly viewing from the top of wick 30.

Turning to FIG. 15 and FIG. 16, wick 230 comprises upper LED 232A, facing upward, mechanically coupled to lower LED 232B, facing downward, with solder 236. Lower LED 232B is further electrically coupled to two pins 234 which can be connected to two-pin position socket 22 as noted above. Wick 230 further comprises shrink tubing 238 fully covering upper LED 232A and partially covering the lower LED 232B to give wick 230 a real wick appearance while lighting a portion of two-pin position socket 22.

Turning to FIG. 17 and FIG. 18, wick 330 comprises upper LED 332A, facing upward, mechanically coupled to lower LED 332B, facing upward, with solder 336. Lower LED 332B is further electrically coupled to two pins 234 which can be connected to two-pin position socket 22 as noted above. Wick 330 further comprises shrink tubing 338 fully covering upper LED 332A and partially covering the lower LED 332B to give wick 330 a real wick appearance without lighting a portion of two-pin position socket 22.

Turning to FIG. 19 and FIG. 20, wick 430 comprises upper LED 432A, facing upward, mechanically coupled to two pins 234 which can be connected to two-pin position socket 22 as noted above. Wick 430 further comprises shrink tubing 438 fully covering upper LED 432A to give wick 330 a real wick appearance without lighting a portion of two-pin position socket 22.

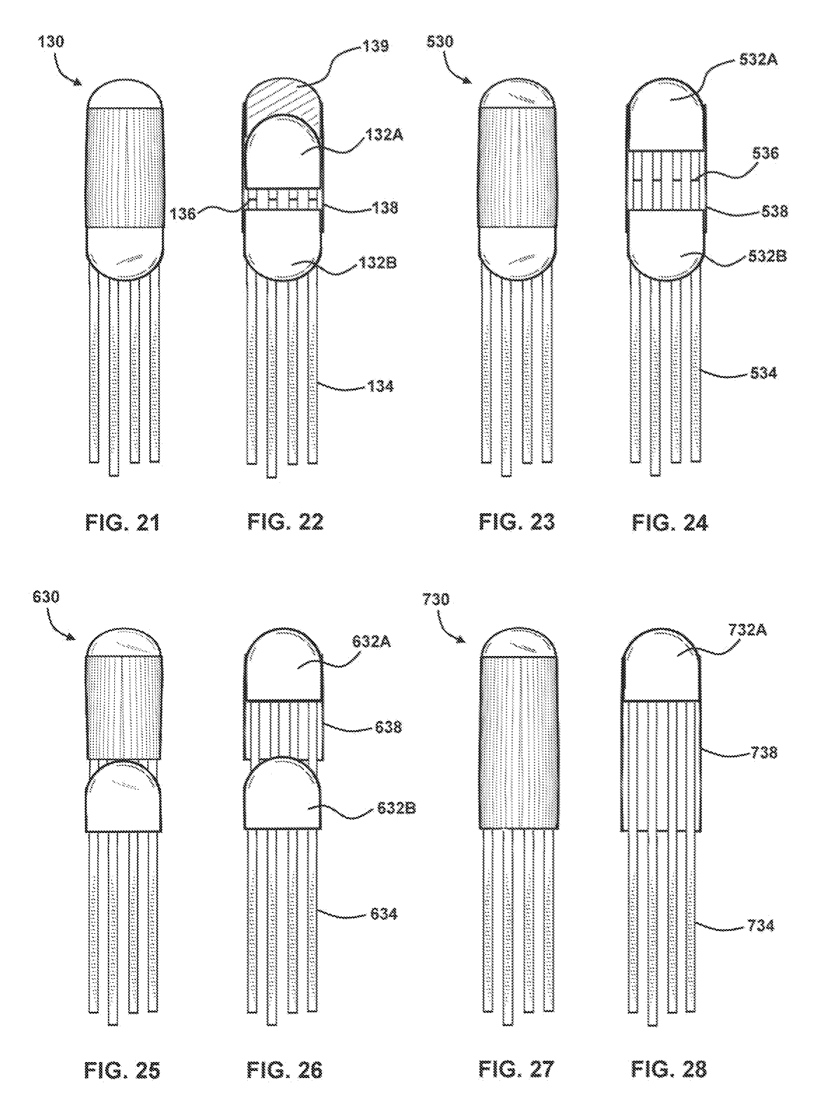

Turning to FIG. 21 and FIG. 22, wick 130 comprises upper RGB LED 132A, facing upward, mechanically coupled to lower RGB LED 132B, facing downward, with solder 136. Lower RGB LED 132B is further electrically coupled to four pins 134 which can be connected to wick receptacle 122 as noted above. Wick 130 further comprises shrink tubing 138 fully covering upper RGB LED 132A and partially covering the lower RGB LED 132B to give wick 130 a real wick appearance. Clear heat glue 129 on the top of upper RGB LED 132A reduces the sharpness of the light to give a softer light when a user is directly viewing from the top of wick 130.

Turning to FIG. 23 and FIG. 24, wick 530 comprises upper RGB LED 532A, facing upward, mechanically coupled to lower RGB LED 532B, facing downward, with solder 536. Lower RGB LED 532B is further electrically coupled to four pins 534 which can be connected to wick receptacle 122 as noted above. Wick 530 further comprises shrink tubing 538 fully covering upper RGB LED 532A and partially covering the lower RGB LED 532B to give wick 530 a real wick appearance while lighting a portion of wick receptacle 122.

Turning to FIG. 25 and FIG. 26, wick 630 comprises upper LED 632A, facing upward, mechanically coupled to lower RGB LED 532B, facing upward, with solder 536. Lower RGB LED 532B is further electrically coupled to four pins 534 which can be connected to wick receptacle 122 as noted above. Wick 530 further comprises shrink tubing 538 fully covering upper RGB LED 532A and partially covering the lower RGB LED 532B to give wick 530 a real wick appearance while lighting a portion of wick receptacle 122.

Turning to FIG. 27 and FIG. 28, wick 730 comprises upper RGB LED 732A, facing upward, mechanically coupled to four pins 734 which can be connected to wick receptacle 122 as noted above. Wick 730 further comprises shrink tubing 738 fully covering upper RGB LED 732A to give wick 730 a real wick appearance while lighting a portion of wick receptacle 122.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A wick assembly configured to resemble a candle in a variety of settings; the wick assembly comprising:
a wick further comprising:
an upper LED facing upward mechanically coupled to at least two pins;
shrink wrap, around the upper LED and altering light diffused from the upper LED;
a wick receptacle further comprising a position socket, configured to accommodate the at least two pins
wherein the upper LED is detachable from the position socket and is configured to be replaced if the upper LED burns out.

2. The wick assembly of claim 1, wherein the at least two pins are four pins and the upper LED is an upper RGB LED.

3. The wick assembly of claim 1, further comprising
a lower LED mechanically coupled to the at least two pins and soldered to the upper LED
wherein the lower LED is partially covered in the shrink wrap in order to alter diffused light from the lower LED.

4. The wick assembly of claim 3, wherein the at least two pins are four pins, the upper LED is an upper RGB LED and the lower LED is a lower RGB LED.

5. The wick assembly of claim 3, further comprising heat glue covering an upper portion of the upper LED to provide muted lighting from the upper LED.

6. The wick assembly of claim 5, wherein the at least two pins are four pins, the upper LED is an upper RGB LED and the lower LED is a lower RGB LED.

7. The wick assembly of claim 3, wherein the lower LED is facing upward to magnify the light from above the wick.

8. The wick assembly of claim 7, wherein the upper LED is an upper RGB LED and the lower LED is a lower RGB LED.

9. The wick assembly of claim 3, wherein the lower LED is facing upward to magnify the light from above the wick.

10. The wick assembly of claim 9, the upper LED is an upper RGB LED and the lower LED is a lower RGB LED.

11. The wick assembly of claim 1, further comprising: an electronic module electrically coupled to the wick receptacle wherein the electronic module further comprises an integrated circuit board electrically coupled to power source.

12. The wick assembly of claim 11, further comprising: a wax candle body configured to cover the wick receptacle and the electronic module to give the wick assembly an appearance of a wax candle.

13. The wick assembly of claim 11, further comprising: a tea candle body configured to cover the wick receptacle and the electronic module to give the wick assembly an appearance of a tea candle.

14. The wick assembly of claim 11, further comprising: a jar candle body configured to cover the wick receptacle and the electronic module to give the wick assembly an appearance of a jar candle.

15. The wick assembly of claim 11, further comprising: a stick candle body configured to cover the wick receptacle and the electronic module to give the wick assembly an appearance of a stick candle.

16. The wick assembly of claim 11;
wherein the wick receptacle is configured to accommodate four pins;
an LED is inserted into two pins on the wick receptacle;
the upper LED has two other pins that are bent at right angles to avoid interfering with the LED.

17. The wick assembly of claim 16; wherein the wick receptacle is detachable coupled to a cap made from transparent plastic covers the LED and the two pins to support an upright position of the wick.

18. The wick assembly of claim 16; wherein the wick receptacle is detachably coupled to a wax candle body giving an appearance of a wax candle.

19. The wick assembly of claim 16; wherein the wick receptacle is detachably coupled to a jar candle body giving an appearance of a jar candle.

20. The wick assembly of claim 16; wherein the wick receptacle is detachably coupled to a tea candle body giving an appearance of a tea candle.
